(19) United States
(12) Patent Application Publication
(10) Pub. No.: US 2008/0083368 A1
(43) Pub. Date: Apr. 10, 2008

(54) Tire protectant applicator

(76) Inventor: Jimmie C. Ward, Lithia Springs, GA (US)

Correspondence Address: JAMES RAY & ASSOCIATES, 2640 PITCAIRN ROAD, MONROEVILLE, PA, 15146, US

(21) Appl. No.: 11/544,390

(22) Filed: Oct. 6, 2006

(51) Int. Cl. B05C 21/00

(52) U.S. Cl. 118/264; 401/196; 401/203

(57) ABSTRACT

An apparatus for applying a tire protectant to a tire and engageable with a squeeze trigger type fluid dispenser. The apparatus comprises a backing member having an aperture formed therethrough disposed in substantially a center portion of the backing member for engagement on a first side thereof with a nozzle end of such squeeze trigger type fluid dispenser. The backing member having each of a first predetermined size and a predetermined shape and made of a first predetermined material. An applicator member is engageable on a first side with the second side of the backing member. The applicator member has each of a second predetermined size and a second predetermined shape and is formed of a second predetermined material. There is a means for securing the applicator member to the backing member.

### FIELD OF THE INVENTION

The present invention relates, in general, to tire protectant, and, more particularly, the present invention relates to an applicator for applying tire protectant without having the protectant drip or run.

### BACKGROUND OF THE INVENTION

Cleaning a vehicle is part of preventative and routine maintenance of the vehicle. For long-lasting protection each part must be cared for adequately. Applying certain products to the vehicle can be hazardous or difficult if the products can run or drip onto other parts and could thereby damage other areas and cause additional work in cleaning. One such product is tire protectant.

Traditionally, tire protectant is applied with a bottled product that is applied through a spray nozzle and sprayed onto the tire surface. When such protectant is sprayed onto the tire there is a good possibility that the protectant can drip or run onto the tire rim or possibly sprayed onto the fender, which creates additional work in cleaning the rims or other body parts to get rid of the unsightly protectant.

Thus, it would be advantageous if there were a way to apply protectant to the tires of a vehicle without running the risk of dripping or running onto other areas of the vehicle.

### SUMMARY OF THE INVENTION

In a first aspect the present invention provides an apparatus for applying a tire protectant to a tire and engageable with a squeeze trigger type fluid dispenser. The apparatus comprises a backing member having an aperture formed therethrough disposed in substantially a center portion of the backing member for engagement on a first side thereof with such squeeze trigger type fluid dispenser. The backing member having each of a first predetermined size and a predetermined shape and made of a first predetermined material. An applicator member is engageable on a first side with the second side of the backing member. The applicator member has each of a second predetermined size and a second predetermined shape and is formed of a second predetermined material. There is a means for securing the applicator member to the backing member.

In a second aspect the present invention provides in combination with a trigger type fluid dispenser in which the trigger sprayer is mounted on an open end of a container, said trigger sprayer including a sprayer body secured to an open end of the container by a rotatable collar, the trigger-type actuator coupled to a pump mechanism disposed within the sprayer body for dispensing a fluid from an outlet end of a nozzle portion mounted on an outlet end of the sprayer body, the improvement comprising apparatus for applying a tire protectant to a tire. There is a backing member having an aperture formed therethrough disposed in substantially a center portion of the backing member for engagement on a first side thereof with the nozzle portion of the trigger type fluid dispenser. The backing member having each of a first predetermined shape and a first predetermined size and formed of a first predetermined material. An applicator member is engageable with a second side of the backing member. The applicator member having each of a second predetermined size and a second predetermined shape and formed of a second predetermined material. There is further a means for securing the applicator member to the backing member.

### OBJECTS OF THE INVENTION

It is, therefore, one of the primary objects of the present invention is to provide an applicator for applying tire protectant to a tire that will not drip or run.

Another object of the present invention is to provide an applicator for applying tire protectant to a tire that will quickly and easily protect tires.

Still another object of the present invention is to provide an applicator for applying tire protectant to a tire that is applied by means of a contoured applicator.

Yet another object of the present invention is to provide an applicator for applying tire protectant to a tire that is applied through a foam or sponge applicator.

Another object of the present invention is to provide an applicator for applying tire protectant to a tire for use with standard size tires and an applicator for use with low profile tires.

Still another object of the present invention is to provide an applicator for applying tire protectant in which the applicators are interchangeable.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the apparatus for applying tire protectant for a standard size tire according to an embodiment of the invention.

FIG. 2 is a perspective view of the apparatus for applying tire protectant for a low profile tire according to an embodiment of the invention.

FIG. 3 is a perspective view of the apparatus shown in FIG. 1 with a profile of the sidewall of a tire.

FIG. 4 is a back view of the backing member according to an alternate embodiment of the invention.

FIG. 5 is side view of the apparatus for applying a protectant to a tire according to the alternate embodiment of the invention.

FIG. 6 is the apparatus shown in FIG. 5 attached to a squeeze trigger type fluid dispenser for applying such tire protectant.

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

The present invention provides a new means for applying a tire protectant to a vehicular tire. In the past tire protectant has been applied by spraying the protectant on the sidewall. Since spraying can not be controlled without great care some of the tire protectant can get on the fender and also the tire protectant could could drip and run on areas such as hub caps. The present invention eliminates the spray applicator and provides an applicator wherein the protectant is applied directly on the tire.

In a first aspect the present invention provides an apparatus, generally designated 10, for applying a tire protectant to a tire and engageable with a squeeze trigger type fluid dispenser, generally designated 20. The apparatus 10 comprises a backing member 2 having an aperture 4 formed therethrough disposed in substantially a center portion of the backing member 2 for engagement on a first side thereof with such squeeze trigger type fluid dispenser 20. The backing member 2 having each of a first predetermined size and a predetermined shape and made of a first predetermined material. An applicator member 6 is engageable on a first side with the second side of the backing member 2. The applicator member 6 has each of a second predetermined size and a second predetermined shape and is formed of a second predetermined material. There is a means, generally designated 30, for securing the applicator member 6 to the backing member 2.

The predetermined shape of backing member 2 and the applicator member 6 are both substantially rectangular. The predetermined shape of the applicator member 6 further includes an arcuate portion 8 on a second side of the applicator member 6. Such arcuate portion 8 is on an outer edge along a longitudinal axis of the second side of the applicator member 6. This arcuate portion 8 is contoured so as to correspond to an outer surface of a tire.

The predetermined material for such applicator member is one of foam and sponge. It is presently preferred that the material is foam. Also the predetermined size of the applicator member 6 is sufficient to apply such protectant to one of a standard size tire or a low profile tire. There is a different size applicator for each a standard tire and a low profile tire. As can be seen in the drawing figures the applicator for the low profile tires is smaller than that for the standard tires. It is preferred that the size for the low profile tire be substantially the size of a credit card, approximately 2⅓ inches wide by 3¾ inches in length with the contour running from top to bottom.

Such tire protectant is thus applied directly on to such tire by means of the applicator member. In this manner the applicator member covers the sidewall portion of the tires easily and there is no mess or danger of spilling or dripping.

It is also a preferred embodiment of the invention that such applicator member 6 that is used for a standard size tire and the applicator member used for a low profile tire be interchangeable on the trigger type dispenser.

It is also presently preferred that the first predetermined material for forming the backing member 2 is plastic. Such backing member can be made of a variety of plastics. It is preferred that such plastic be compatible with the plastic that is presently found on squeeze trigger type fluid dispensers. In a presently preferred embodiment of the invention such backing member and the squeeze tripper-type fluid dispenser are molded as a unitary member.

Such applicator member 6 is secured to the backing member 2 by means of an adhesive.

In a second aspect the present invention provides in combination with a trigger type fluid dispenser 20 in which the trigger sprayer is mounted on an open end of a container, the trigger sprayer including a sprayer body secured to an open end of the container by a rotatable collar, the trigger-type actuator coupled to a pump mechanism disposed within the sprayer body for dispensing a fluid from an outlet end of a nozzle portion mounted on an outlet end of the sprayer body, the improvement comprising apparatus 10 for applying a tire protectant to a tire. There is a backing member 2 having an aperture 4 formed therethrough disposed in substantially a center portion of the backing member for engagement on a first side thereof with the nozzle portion of the trigger-type fluid dispenser. The backing member 2 having each of a first predetermined shape and a first predetermined size and formed of a first predetermined material. An applicator member 6 is engageable with a second side of the backing member 2. The applicator member 6 having each of a second predetermined size and a second predetermined shape and formed of a second predetermined material. There is further a means 30 for securing the applicator member 6 to the backing member 2.

The predetermined shape of such backing member 2 and such applicator member 6 are substantially rectangular. However, the predetermined shape of the applicator member 6 further includes an arcuate portion 8 on a second side. The arcuate portion 8 is on an outer edge along a longitudinal axis of the aid second side of the applicator member 6 and is contoured so as to correspond to an outer surface of a tire.

It is presently preferred that such predetermined material for the applicator member 6 be one of foam and sponge.

In an alternate embodiment of the invention several small portals about the size of a toothpick or a very thin straw would be formed in the foam applicator from the backing member to substantially half of the distance from the backing member to the contoured part of the applicator. There are a plurality of portals. These portals would assist moving the tire protectant to the applicator surface area. The portals would fan out from the backing plate toward the contoured surface of the applicator so as to assist the protectant reaching all of the surface area quickly.

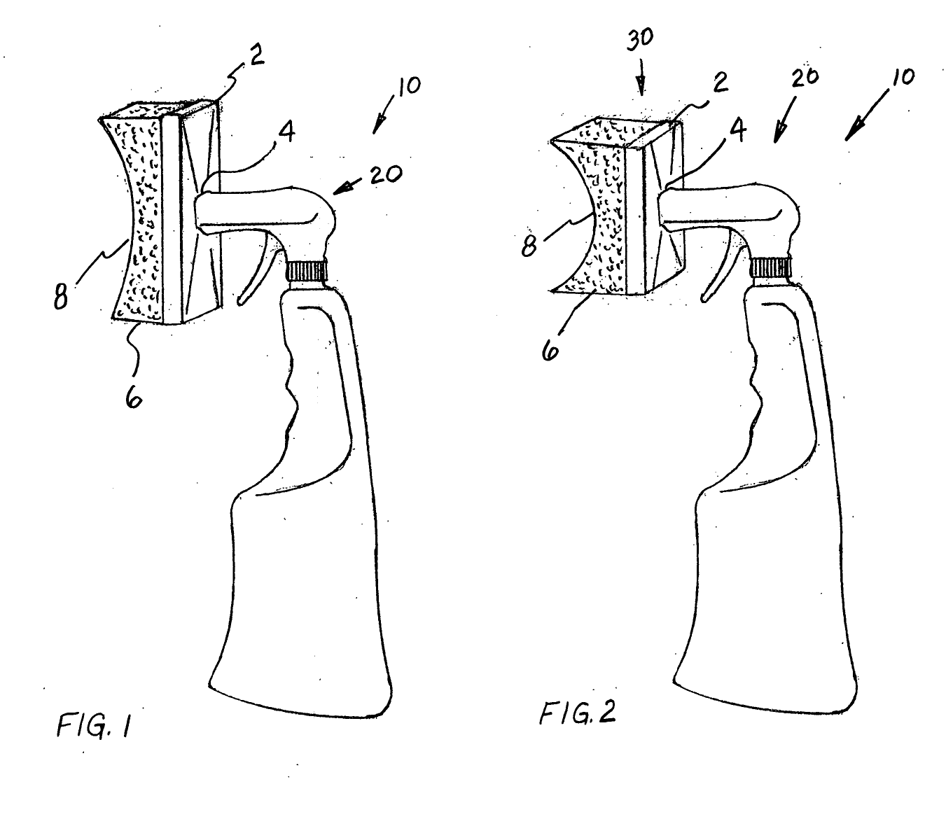

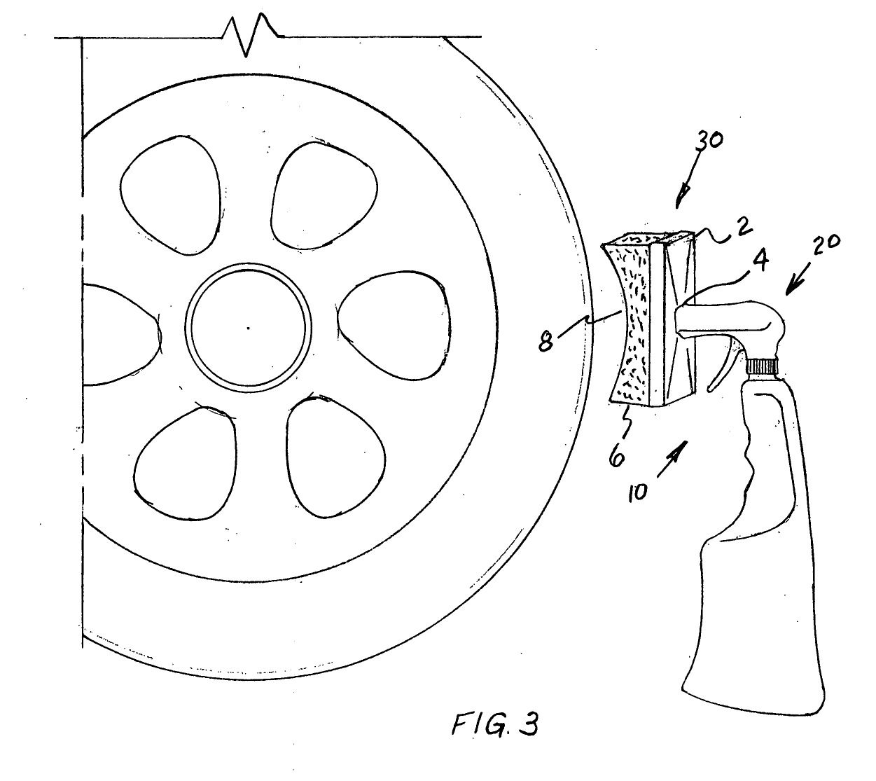

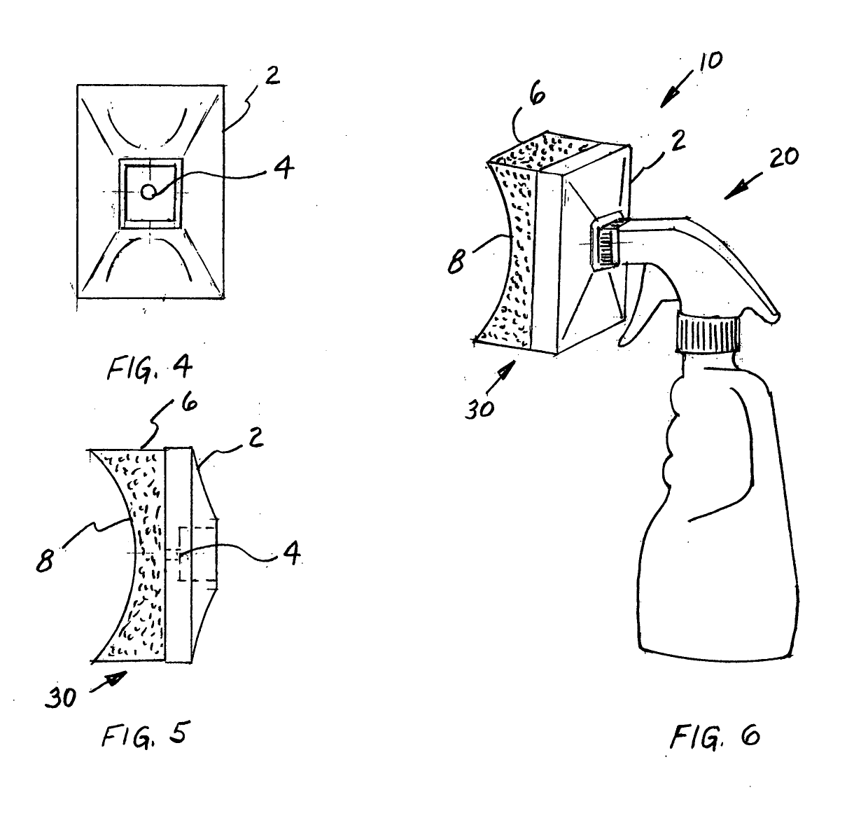

FIGS. 1-3 show the apparatus 10 engageable with such trigger type fluid dispenser 20 wherein the backing member 2 is formed as a unitary member with the body of the trigger type fluid dispenser 20. FIGS. 4-6 show the apparatus 10 that is engageable with the trigger type fluid dispenser as a separate part.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

I claim:

1. An apparatus for applying a tire protectant to a tire and engageable with a squeeze trigger type fluid dispenser, said apparatus comprising:
(a) a backing member having an aperture formed therethrough disposed in substantially a center portion of said backing member for engagement on a first side thereof with said squeeze trigger type fluid dispenser, said backing member having each of a first predetermined size and a predetermined shape and made of a first predetermined material; and
(b) an applicator member engageable on a first side with a second side of said backing member, said applicator member having each of a second predetermined size and a second predetermined shape and formed of a second predetermined material; and
(c) a means for securing said applicator member to said backing member.

2. The apparatus, according to claim 1, wherein said predetermined shape of said backing member is substantially rectangular.

3. The apparatus, according to claim 2, wherein said predetermined shape of said applicator member is substantially rectangular.

4. The apparatus, according to claim 3, wherein said predetermined shape of said applicator member further includes an arcuate portion on a second side.

5. The apparatus, according to claim 4, wherein said arcuate portion is on an outer edge along a longitudinal axis of said second side of said applicator member.

6. The apparatus, according to claim 5, wherein said arcuate portion of said applicator member is contoured so as to correspond to an outer surface of a tire.

7. The apparatus, according to claim 1, wherein said second predetermined material is one of foam and sponge.

8. The apparatus, according to claim 7, wherein said second predetermined material is foam.

9. The apparatus, according to claim 1, wherein said predetermined size of said applicator is sufficient to apply such protectant to one of a standard size tire and a low profile tire.

10. The apparatus, according to claim 1, wherein said first predetermined material of said backing member is plastic.

11. The apparatus, according to claim 7, wherein said applicator member for a standard size tire and said applicator member for a low profile tire are interchangeable on said trigger type dispenser.

12. The apparatus, according to claim 1, wherein such tire protectant is applied directly on to such tire by means of said applicator member.

13. The apparatus, according to claim 1, wherein said applicator member is secured to said backing member by means of an adhesive.

14. The apparatus, according to claim 1, wherein said backing member and a body portion of said squeeze trigger type fluid dispenser are molded as a single unit.

15. In combination with a squeeze trigger type fluid dispenser in which said squeeze trigger type fluid dispenser is mounted on an open end of a container, said trigger sprayer including a sprayer body secured to an open end of said container by a rotatable collar, said trigger-type actuator coupled to a pump mechanism disposed within said sprayer body for dispensing a fluid from an outlet end of a nozzle portion mounted on an outlet end of said sprayer body, the improvement comprising apparatus for applying a tire protectant to a tire:
(a) a backing member having an aperture formed therethrough disposed in substantially a center portion of said backing member for engagement on a first side thereof with said nozzle portion of said trigger type fluid dispenser, said backing member having each of a first predetermined shape and first predetermined size and formed of a first predetermined material;
(b) an applicator member engageable with a second side of said backing member, said applicator member having each of a second predetermined size and a second predetermined shape and formed of a second predetermined material; and
(c) a means for securing said applicator member to said backing member.

16. The combination, according to claim 15, wherein said predetermined shape of said backing member and said applicator member is substantially rectangular.

17. The combination, according to claim 16, wherein said predetermined shape of said applicator member further includes an arcuate portion on a second side.

18. The combination, according to claim 17, wherein said arcuate portion is on an outer edge along a longitudinal axis of said second side of said applicator member.

19. The combination, according to claim 18, wherein said arcuate portion of said applicator member is contoured so as to correspond to an outer surface of a tire.

20. The combination, according to claim 15, wherein said second predetermined material is one of foam and sponge.
